(19) United States
(12) Patent Application Publication
(10) Pub. No.: US 2018/0195563 A1
(43) Pub. Date: Jul. 12, 2018

(54) MOTION CONTROL SYSTEMS, DEVICES, AND METHODS FOR ROTARY ACTUATORS SYSTEMS

(71) Applicant: LORD Corporation, Cary, NC (US)

(72) Inventors: Stefan BARBULESCU, Fuquay-Varina, NC (US); Richard WILDER, Moncure, NC (US); Joshua FISHMAN, Raleigh, NC (US); Michael TRULL, Apex, NC (US); Askari BADRE-ALAM, Cary, NC (US)

(21) Appl. No.: 15/743,545

(22) PCT Filed: Jul. 21, 2016
(86) PCT No.: PCT/US2016/043349

§ 371 Date: Jan. 10, 2018

Related U.S. Application Data
(60) Provisional application No. 62/222,981, filed on Sep. 24, 2015.
(60) Provisional application No. 62/195,004, filed on Jul. 21, 2015.
(60) Provisional application No. 62/195,012, filed on Jul. 21, 2015.

(51) Int. Cl. F16D 49/08; F16D 65/06

(52) U.S. Cl. CPC F16D 49/08; F16D 2121/20; F16D 65/065

(57) ABSTRACT

Motion control systems, devices, and methods are operable for controlling rotary motion of an actuated device. In one aspect, a motion control device is coupled between an external motive input (200) and a rotary output device (300). The motion control device has a brake core (110) configured to produce an electromagnetic field when an electric current is applied. A brake band (130) made of a magnetically responsive material surrounds the brake core (110) and is coupled to the brake core (110) when the electric current is applied. A rotor (120) that is coupled to both the external motive input (200) and the rotary output surrounds at least the perimeter of the brake band (130) and is coupled to the brake band (130) for rotation together. When the electric current is applied, the rotor (120) and the brake core (110) are thus rotatably locked together to control rotary motion generated by actuating forces imparted by the external motive input (200).

### CROSS REFERENCE TO RELATED APPLICATION

This application relates to and claims priority to U.S. Provisional Patent Application Ser. No. 62/195,012, filed on Jul. 21, 2015, U.S. Provisional Patent Application Ser. No. 62/195,004, filed on Jul. 21, 2015, and U.S. Provisional Patent Application Ser. No. 62/222,981, filed on Sep. 24, 2015, the disclosures of which are incorporated by reference herein in their entireties.

### TECHNICAL FIELD

The present subject matter relates to a motion control device. In particular, the present subject matter relates to motion control devices that couple an external motive input to a rotary output device.

### BACKGROUND

Modern vehicles incorporate different types of actuators for driving different types of devices, or portions thereof. For example, modern vehicles may include actuated valves, dampers, compressors, cylinders, exhaust components, pumps, engine components, or the like.

Conventional locking devices often exhibit limited functionality, however, as they can only lock the position of the actuated device, or portions thereof, in one extreme state or another, namely in a purely “start” or “stop” state and/or a purely “open” or “closed” state. Accordingly, such devices are generally unable to provide precise position locking at positions between the two extreme states, which can provide desirable results in some configurations, such as to decrease sound, increase torque at low RPM, increase performance, etc.

Accordingly, it would be advantageous for improved devices, systems, and methods to be able to brake, lock, and/or otherwise hold the position of an actuated device at various positions between extreme states (e.g., between fully open and/or fully closed states).

### SUMMARY

In one aspect, a motion control device for a rotary actuator system is provided. The motion control device comprising a brake core, a rotor, a brake band, an external motive input a rotary output device and an external control input. The brake core includes a coil configured to generate an electromagnetic field when an electric current is applied. The rotor is positioned about and rotatable relative to the brake core. The brake band is positioned between the rotor and the brake core, the brake band being coupled to the rotor for rotation therewith and includes a magnetically responsive material. The external motive input is coupled to the rotor and configured for angular movement upon rotation of the rotor relative to the brake core. The rotary output device is coupled to the rotor and configured for angular movement upon rotation of the rotor relative to the brake core. The external control input is configured to selectively provide the electric current to the coil. Wherein, energizing the coil causes the brake band to be magnetically coupled with the brake core to prevent relative movement between the rotor and the brake core.

In another aspect, a method for adjusting, changing, and/or locking a position of an actuated device to any of a range of desired positions between two extreme states is provided. The method comprises the steps of providing a rotor about and rotatable relative to a brake core, the brake core including a coil configured to generate an electromagnetic field when an electric current is applied; providing a brake band between the rotor and the brake core, the brake band being coupled with the rotor for rotation therewith, the brake band including a magnetically responsive material; coupling an external motive input to the rotor, the external motive input being movable to cause the rotor to rotate relative to the brake core; coupling a rotary output device to the rotor, the rotary output device being configured for angular movement upon rotation of the rotor relative to the brake core; upon receipt of a first control input, controlling a position of the rotary output device by applying the electric current to the coil, wherein applying the electric current to the coil causes the brake band to be magnetically coupled to the brake core to prevent relative movement between the rotor and the brake core; and upon receipt of a second control input, disconnecting the electric current from the coil, wherein disconnecting the electric current from the coil causes the brake band to be decoupled from the brake core to allow free rotation therebetween.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1 is a block diagram of an actuator system that includes a brake assembly according to an embodiment of the presently disclosed subject matter.

FIGS. 2A-2B are different side sectional views of a brake assembly according to an embodiment of the presently disclosed subject matter.

FIGS. 3A-3B are different side sectional views of a brake assembly according to another embodiment of the presently disclosed subject matter.

FIGS. 4A-4C are side views of several configurations for a brake band according to embodiments of the presently disclosed subject matter.

FIGS. 5-8 are perspective views of a brake assembly according to an embodiment of the presently disclosed subject matter.

FIG. 9 is a partial sectional side view of the brake assembly shown in FIGS. 5-8.

FIG. 10 is a perspective view of a brake assembly according to an embodiment of the presently disclosed subject matter.

FIG. 11 is an exploded perspective view of the brake assembly shown in FIG. 10.

FIG. 12 is a perspective view of a brake assembly according to an embodiment of the presently disclosed subject matter.

### DETAILED DESCRIPTION

The present subject matter provides motion control systems, devices, and methods for rotary actuators systems. In particular, the present subject matter provides systems, devices, and methods that function to adjust, change, and/or lock the position of an actuated (i.e., movable) device to any of a range of desired positions between two extreme states, such as any position between a purely “start” state and a purely “stop” state (also known as “on” and “off” or “open” and “closed”). In some embodiments, for example, the present subject matter provides for high-resolution of position control, which is sometimes referred to as infinitely variable position control. To achieve such control, the present systems, devices, and methods include an electromagnetic braking element that is selectively operable to stop the position of the actuated device at a desired state and/or position. As used herein, the term “brake” is used to describe the embodiments of the present subject matter in which a torque-generating device creates a dissipative torque in response to signals received or generated by the device.

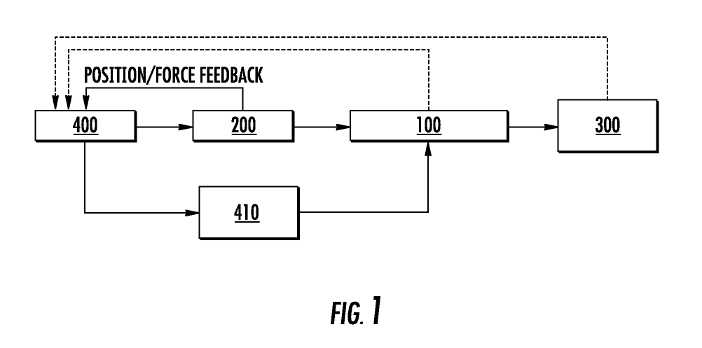

In this regard, FIG. 1 illustrates one exemplary schematic configuration for such a motion control device. As shown in FIG. 1, the motion control device comprises a brake assembly, generally designated 100, which is positioned between an external motive input 200 and a rotary output device 300. As described herein, external motive input 200 may include any type of driving component, device, or member. For example, non-limiting examples of external motive input 200 comprise actuators selected from the group consisting of servo motors, electrical motors, linear actuators, a vacuum source, an electromechanical actuator, a magnetic source, a hydraulic source, and combinations thereof. Additional examples include electrical actuators, mechanical actuators, electromechanical actuators, pneumatic actuators, hydraulic actuators, vacuum actuators, diaphragm-type actuators, thermal actuators, magnetic actuators, etc., and/or any combination thereof. In yet further embodiments, external motive input 200 is a human input, such as a lever, knob, wheel, or other mechanism that is selectively movable by a user. Likewise, in some embodiments, rotary output device 300 described herein includes any of a variety of movable devices, components, or members within a vehicle and/or vehicular system. For example, non-limiting examples of actuated devices include valves, gears, dampers, compressors, cylinders, exhaust components, pumps, engine components, pistons, etc., and/or any combination thereof. By way of specific example, where rotary output device 300 is an exhaust valve in a vehicle, locking rotary output device 300 in different positions may be desirable to increase performance of the exhaust system, the vehicle, and/or reduce noise, where desired.

In any configuration, external motive input 200 is configured to be selectively movable between first and second operating states (e.g., “ON” and “OFF”), which correspond to first and second operating positions of rotary output device 300 (e.g., “open” and “closed”). In some embodiments, for example, one or more controller 400 is in communication with external motive input 200 and/or with one or both of brake assembly 100 or rotary output device 300 and is configured to selectively actuate the external motive input 200 to move between its first and second operating states and/or to selectively activate brake assembly 100 to generate and apply a holding force (e.g., a force that is greater than the actuating force) to portions of external motive input 200 for locking rotary output device 300 attached thereto in any desired position, including any of a range of intermediate states between the first and second operating states. In some embodiments, a current source 410 is provided in communication between controller 400 and brake assembly 100 and is operable to selectively energize an electromagnetic element of brake assembly 100. In some embodiments, controller 400 is a black box provided by the customer providing on/off input.

Furthermore, in some embodiments, controller 400 receives input from at least one sensor (See, e.g., dashed lines in FIG. 1) and operates external motive input 200 and brake assembly 100 together to generate movement of external motive input 200 to a predetermined position. In such configurations, the positioning is determined by the on/off of an electrical current supplied by or controlled by the controller.

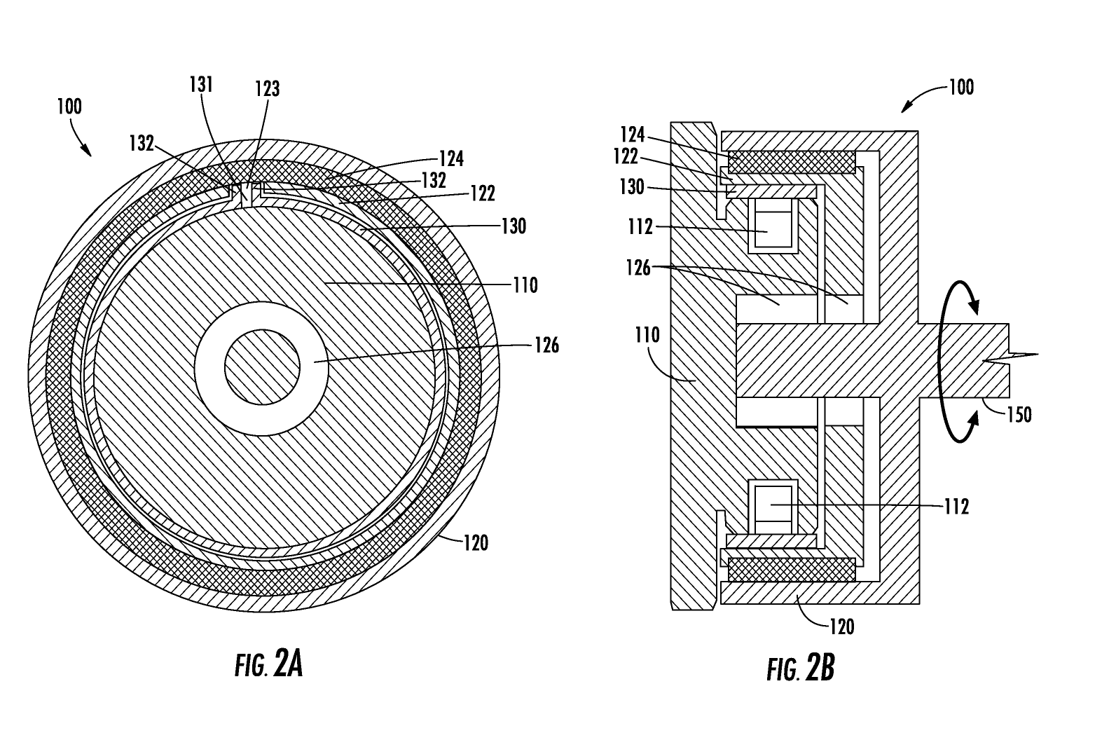

As indicated above, to achieve the desired control over the resulting position of external motive input 200, brake assembly 100 includes an electromagnetic braking element that is selectively operable to stop the position of the actuated device at a desired state. In one embodiment illustrated in FIGS. 2A and 2B, for example, brake assembly 100 comprises a brake core 110 comprising a coil 112 configured to generate an electromagnetic field when an electric current is applied. For example, brake core 110 comprises a magnetically responsive material, such as a material selected from the group consisting of iron, nickel, cobalt, a ferromagnetic material, and steel. As illustrated, coil 112 includes a coil winding that is wrapped about a circumferential perimeter of brake core 110. Although one coil 112 is shown, multiple coils 112 may be provided about an outer circumference of brake core 110. In any configuration, coil 112 is connected to an electrical current source (e.g., current source 410) for selective energization of coil 112.

A rotor 120 is positioned about and rotatable relative to brake core 110, such as by way of one or more bearings 126. A brake band 130 is positioned between rotor 120 and brake core 110, brake band 130 being coupled to rotor 120 for rotation therewith and comprising a magnetically responsive material (e.g., iron, nickel, cobalt, a ferromagnetic material, steel). In some embodiments, such as is shown in FIGS. 2A and 2B, brake band 130 is coupled to rotor 120 by a cup 122 that is positioned between rotor 120 and brake band 130, cup 122 being coupled to both rotor 120 and brake band 130 for rotation together. In this configuration, cup 122 is coupled within rotor 120 by a friction pad 124 or other coupling element that translates the rotation of rotor 120 to cup 122. Cup 122 is further coupled to brake band 130 for rotation together. In some embodiments, for example, as shown in FIG. 2A, brake band 130 is substantially ring-shaped with a gap 131 in one portion of the ring, brake band 130 comprising one or more tabs 132 that extend radially outward from the ends of the split-ring shape of brake band 130 (i.e., at or near opposing sides of gap 131) towards rotor 120 for coupling with rotor 120. In this configuration, cup 122 includes a recess 123 in an interior wall of cup 122 that is sized to receive tabs 132 such that tabs 132 interface with recess 123. In this way, although neither cup 122 nor rotor 120 is physically joined to brake band 130, brake band 130 is still coupled for rotation with rotor 120 and cup 122 due to a force exerted on tabs 132 of brake band 130 by the sidewalls of recess 123. Regardless of the particular embodiment, gap 131 is sized to be large enough that brake band 130 is not prevented from contacting brake core 110 by an interference between the tabs 132 when the electric current is applied to generate the electromagnetic field.

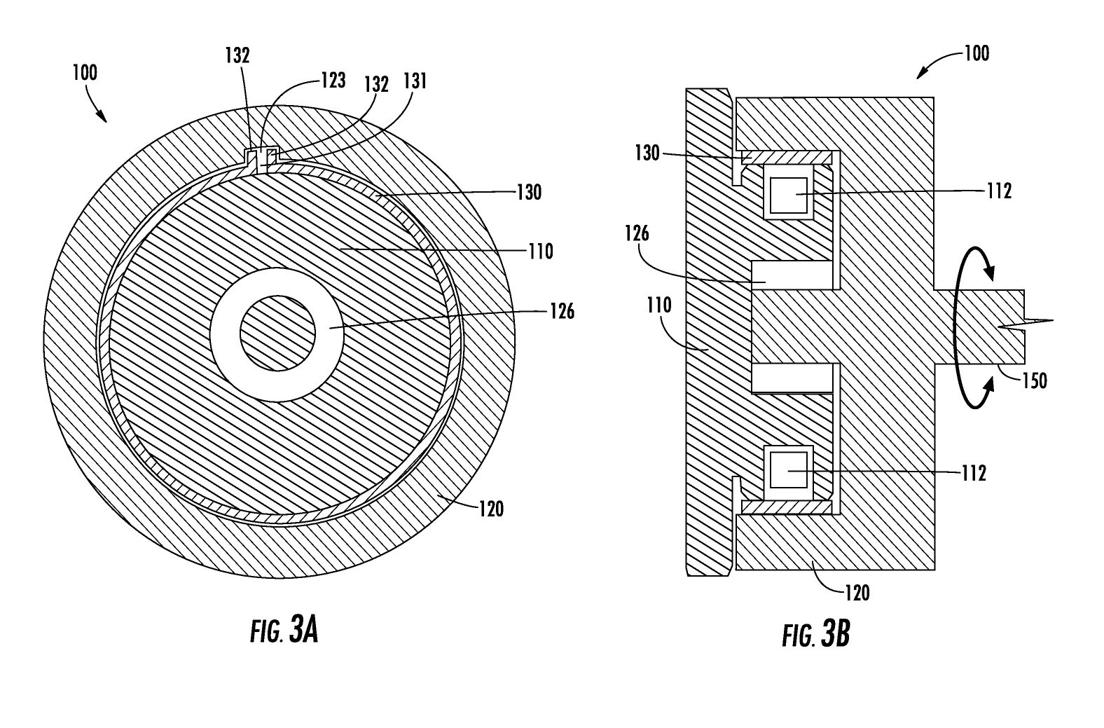

Alternatively, FIGS. 3A and 3B illustrate configurations for brake assembly 100 in which cup 122 is not provided between rotor 120 and brake band 130. Rather, in this alternative configuration, only brake band 130 is positioned between rotor 120 and brake core 110, and recess 123 is provided in rotor 120 itself for receiving tabs 132 such that tabs 132 interface with recess 123 and couple brake band 130 to rotor 120 for rotation together. In this arrangement, although brake band 130 still is not fixedly connected to rotor 120, brake band 130 is coupled for rotation with rotor 120 due to the sidewalls of recess 123 exerting a force on tabs 132 of brake band 130.

Regardless of the particular configuration, brake band 130 is operable to selectively exert a holding force on rotor 120 upon activation of coil 112. Specifically, when coil 112 is in a non-energized state, brake band 130 is rotatable with rotor 120 relative to brake core 110 such that movement of rotor 120 is substantially unimpeded. In some embodiments, brake assembly 100 comprises lubricant (e.g., oil, grease) between at least rotor 120 and brake core 110. This lubricant reduces friction between brake band 130 and brake core 110 and improves the wear resistance of the components. The lubricant has an additional benefit of improving braking performance by substantially reducing the coefficient of static friction to be reduced; in some instances, the coefficient of static friction can be reduced such that it is substantially similar to the coefficient of kinetic friction.

Upon energizing coil 112, however, brake band 130 is magnetically coupled to brake core 110. In some embodiments, where brake band 130 has a split ring shape as shown in FIGS. 2A and 3A, actuation of coil 112 pulls brake band 130 inward, which causes brake band 130 to flex such that the ends of the split ring move towards each other (i.e., narrowing and/or closing gap 131). This effectively reduces the diameter of brake band 130. In this way, the magnetic field applied to brake band 130 acts to both magnetically attract brake band 130 to brake core 110 and to constrict brake band 130 about brake core 110 to generate a frictional holding force between brake band 130 and brake core 110. Accordingly, actuation of brake band 130 produces a high-force-density coupling of brake band 130 with brake core 110. Even in configurations in which the interfaces between components of brake assembly 110 are lubricated as indicated above, this engagement of brake band 130 with brake core 110 is sufficiently strong to impede the further rotation of rotor 120. In some embodiments, brake assembly 100 provides no more than 1N of force when in an “off” state (i.e., coil 112 not energized), but it can exert up to 384N or more of holding force when activated. In addition, in some embodiments, this high force density is produced using as little as 1 W of power for actuation. That being said, those having ordinary skill in the art will recognize that the force generated can be substantially greater or lower depending on the size and configuration of brake assembly 100.

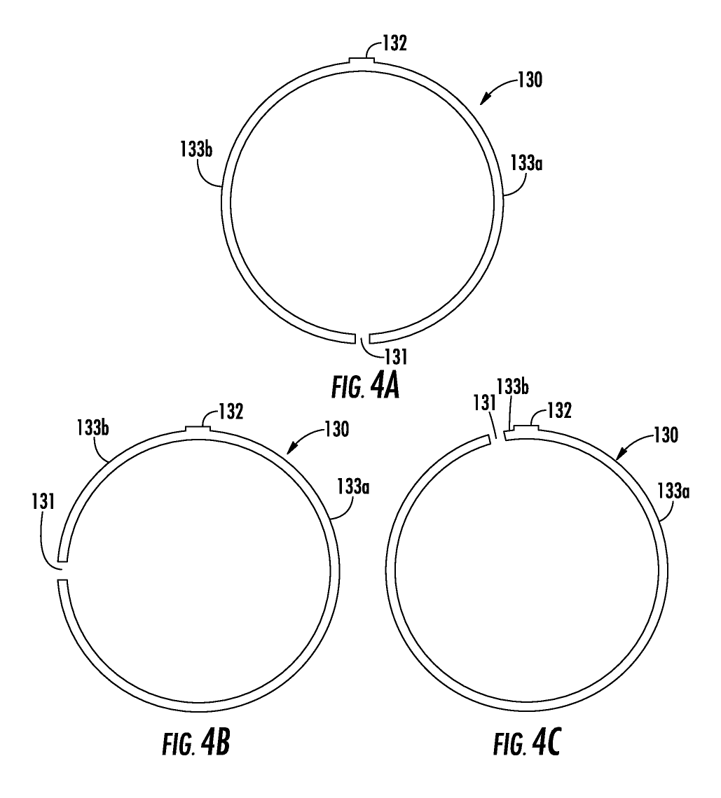

Further alternative configurations of brake band 130 are contemplated for use with brake assembly 100 to provide additional control over the holding force generated when coil 112 is energized. For example, referring to FIG. 4A, brake band 130 again has a split-ring configuration such that, upon application of a magnetic field, brake band 130 constricts about brake core 110 (not shown in FIG. 4A) to generate a frictional holding force between brake band 130 and brake core 110. In addition, tab 132 extends radially outward for coupling with rotor 120 (e.g., either directly or by coupling to a cup element as illustrated in FIGS. 2A-2B). In contrast to the configurations illustrated in FIGS. 2A and 3A, however, rather than being substantially collocated with one or both ends of the split ring (i.e., on either side of gap 131), tab 132 in the configuration of brake band 130 shown in FIG. 4A extends from a portion of brake band 130 that is substantially diametrically opposed from gap 131. In this arrangement, brake band 130 can be characterized as being divided into first and second circumferential portions 133a and 133b of substantially equal length that together extend around substantially an entire circumference of brake core 110, each of first and second circumferential portions 133a and 133b having a proximal end coupled to tab 132, but the distal ends thereof being separated by gap 131. Accordingly, when gap 131 is formed at a position substantially diametrically opposite of tab 132, the holding force applied to rotor 120 is substantially uniform regardless of which direction rotor 120 is rotated. To minimize device mass, it is also possible for the first and second circumferential portions 133a and 133b to extend around only a portion of the circumference of brake core 110, thereby leaving a portion substantially larger than the gap 131, illustrated in FIG. 4A, unoccupied by either of the circumferential portions 133a or 133b.

By comparison, in a further alternative configuration illustrated in FIGS. 4B-4C, gap 131 is formed at a position other than substantially opposite of tab 132 so that one circumferential portion is longer than the other circumferential portion (e.g., a length of first circumferential portion 133a is greater than a length of second circumferential portion 133b). In this arrangement, the holding force applied to rotor 120 differs depending on which direction rotor 120 is rotated. In such situations where the first and second circumferential portions 133a and 133b are of different lengths because of the location of gap 131 in brake band 130, the holding force applied in each direction of rotation is a function of the length of a corresponding one of the first or second circumferential portions 133a or 133b, measured from tab 132, which is opposite the direction of the holding force being applied. By way of two specific exemplary configurations illustrated in FIGS. 4B and 4C, if the holding force is being applied in a counterclockwise direction (e.g., to counteract a clockwise actuating force being imparted to rotor 120) then the amount of holding force generated is a function of the length of the portion of brake band 130 in the clockwise direction (i.e., the length of first circumferential portion 133a), measured from tab 132 to gap 131. The converse is also true, such that a holding force being applied in a clockwise direction is a function of the length of the portion of brake band 130 in the counterclockwise direction (i.e., the length of second circumferential portion 133b), measured from tab 132 to gap 131. Furthermore, this directional difference in the holding force applied can be tuned by selecting the relative lengths of first and second circumferential portions 133a and 133b, which would correspond to a desired holding force in each direction of rotation. For example, a larger difference between clockwise and counterclockwise holding forces is realized in the embodiment shown in FIG. 4C than in the embodiment shown in FIG. 4B. These embodiments enabling differential holding forces can be implemented with any of the other embodiments recited elsewhere herein.

In some embodiments, the holding force applied is otherwise controllable by changing the coefficient of friction for the surfaces of brake core 110, rotor 120, cup 122, friction pad 124, and/or brake band 130 by a plating process, altering the material composition of one or more of these structures, or applying a surface coating or texture thereto.

In any of the above-described configurations, since the rotation of rotor 120 is coupled with brake band 130 (e.g., by the engagement of tabs 132 with recess 123, as discussed above), this electromagnetic engagement of brake band 130 with brake core 110 likewise couples rotor 120 with brake core 110, thereby preventing relative movement between rotor 120 and brake core 110. In some embodiments where the components involved in applying the holding force are relatively small, lightweight, and of compact size, the activation of brake assembly 110 has a fast response time (e.g., on the order of milliseconds), which results in effectively instantaneous locking and unlocking. For brake assembly 100 to act as a braking mechanism, in some embodiments, brake core 110 is fixedly connected to a surrounding support structure so that its position is substantially fixed with respect to the movable components of brake assembly 100. Accordingly, when coil 112 of brake core 110 is energized and brake band 130 engages brake core 110, the resulting coupling of rotor 120 to brake core 110 effectively holds rotor 120 in a substantially fixed angular position.

As discussed above, brake assembly 100 is configured to serve as a motion control device between external motive input 200 and rotary output device 300. In this regard, external motive input 200 is coupled to rotor 120, external motive input 200 being movable to cause rotor 120 to rotate relative to brake core 110, and rotor 120 is further coupled to rotary output device 300. In this arrangement, rotary output device 300 is configured for angular movement upon rotation of rotor 120 relative to brake core 110. An external control input (e.g., controller 400 shown in FIG. 1) is configured to selectively provide the electric current to coil 112. Energizing coil 112 causes brake band 130 to be magnetically coupled to brake core 110 to prevent relative movement between rotor 120 and brake core 110.

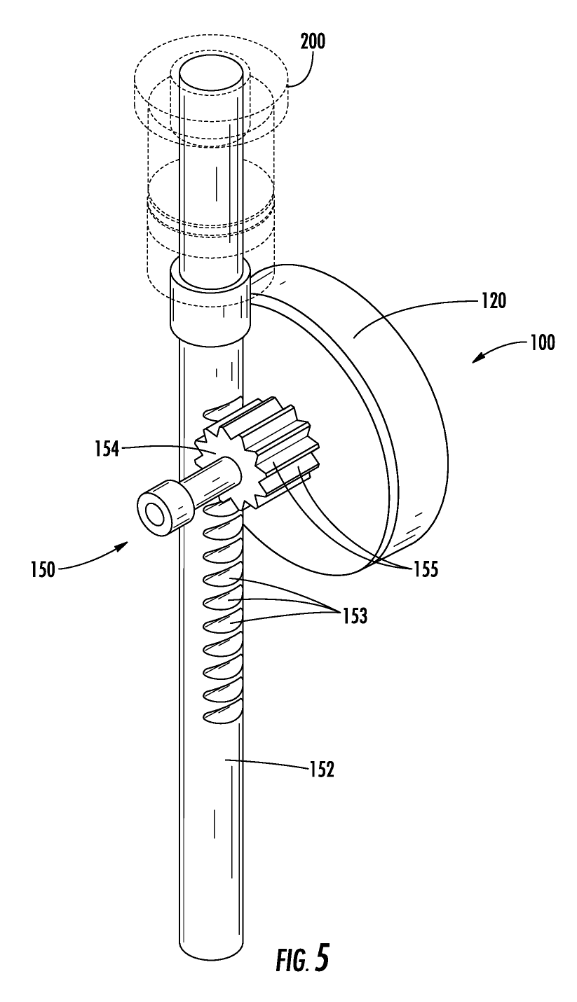

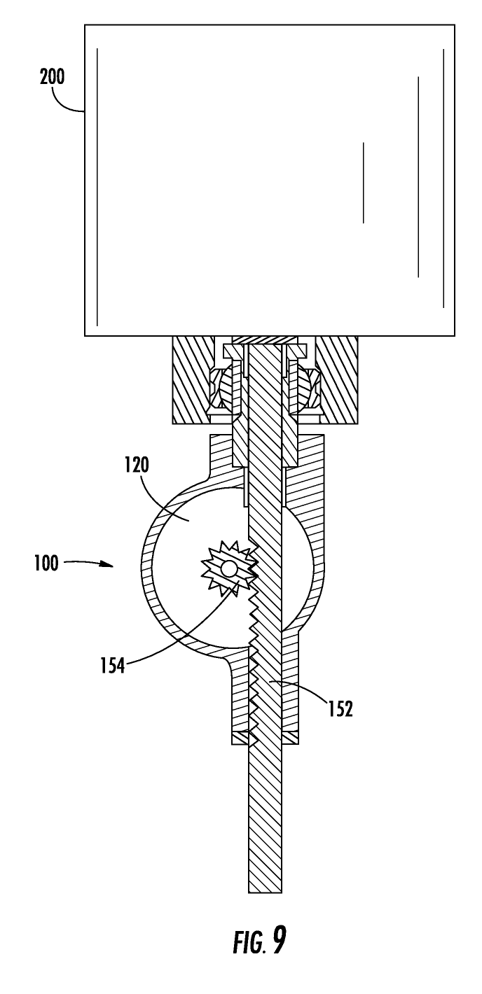

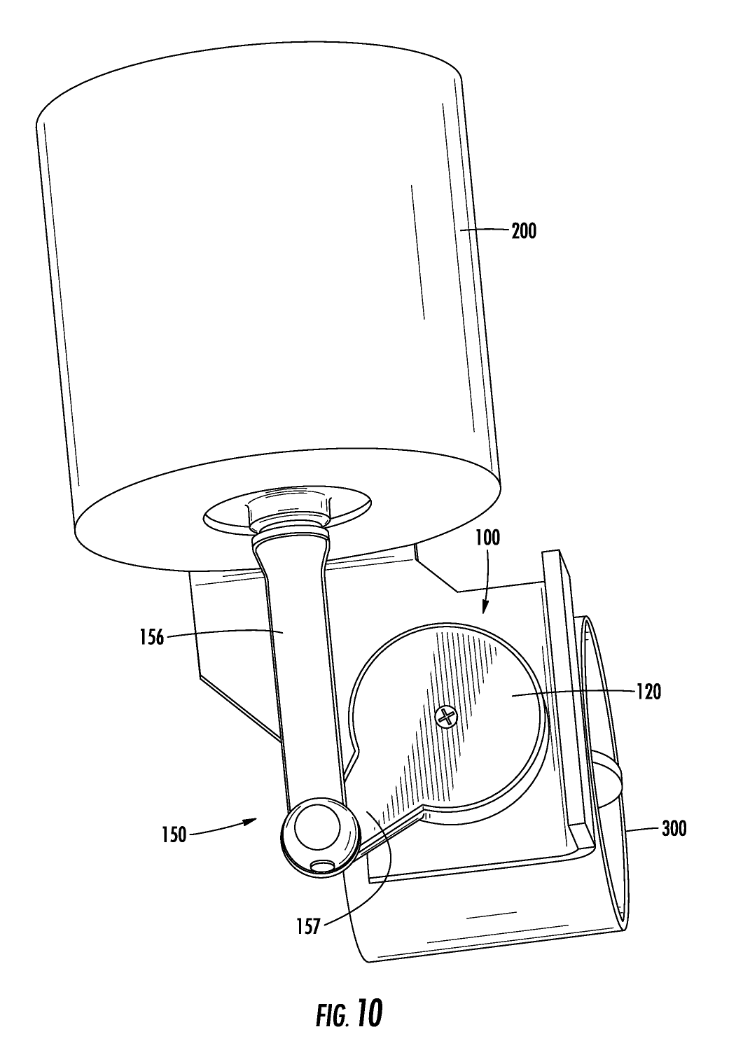

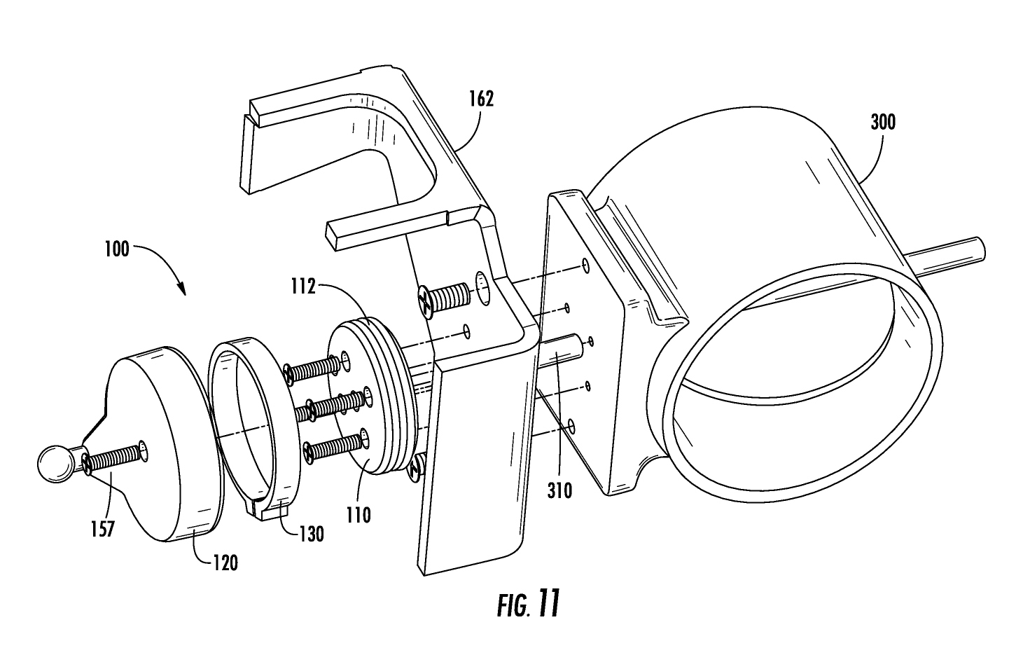

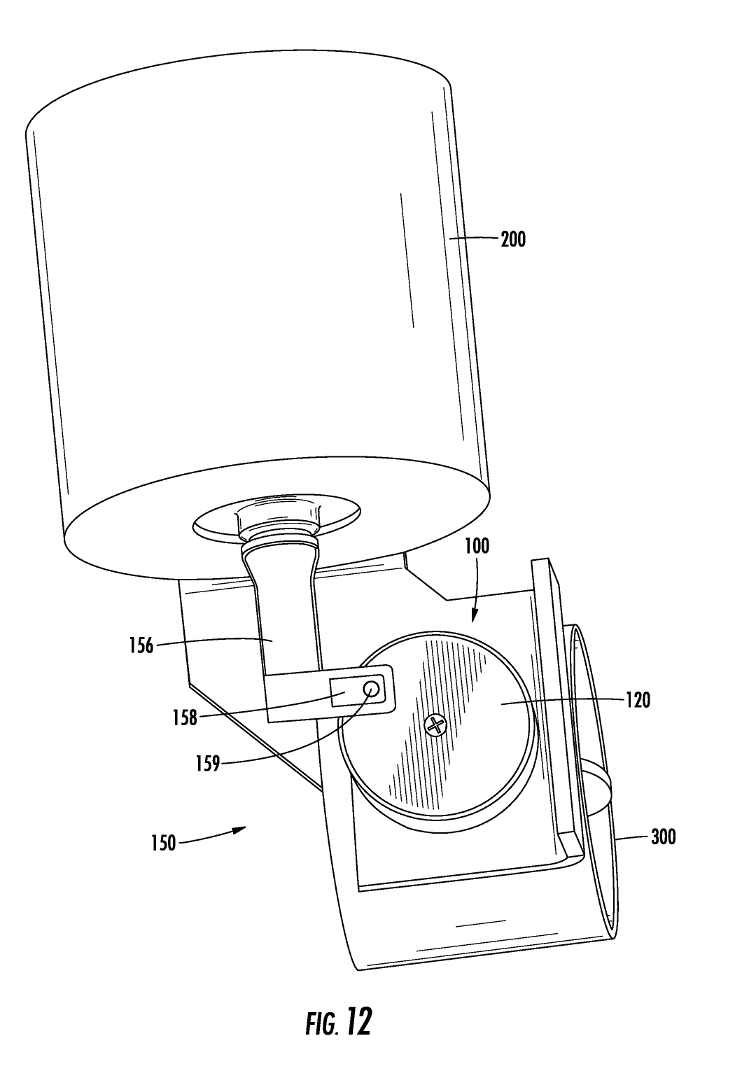

In particular, external motive input 200 is coupled to rotor 120 by a coupling element 150 comprising any of a variety of mechanisms, For example, coupling element 150 can comprise a rack and pinion arrangement (See, e.g., FIGS. 5-9), a crank arm and connecting rod arrangement (See, e.g., FIGS. 10-11), a yoke and connecting rod arrangement (See, e.g., FIG. 12), or any other type of coupling mechanism known to those having skill in the art.

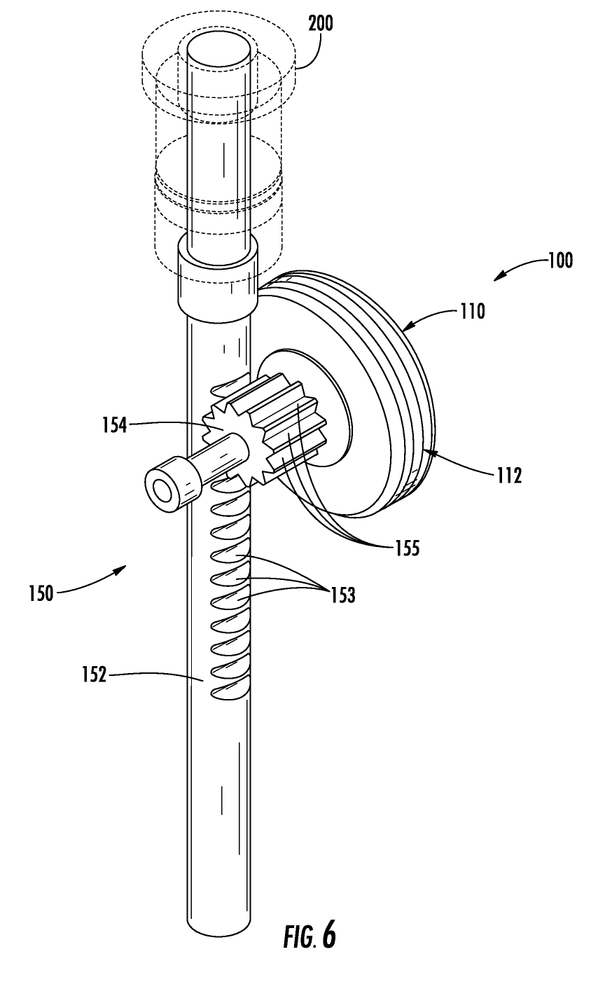

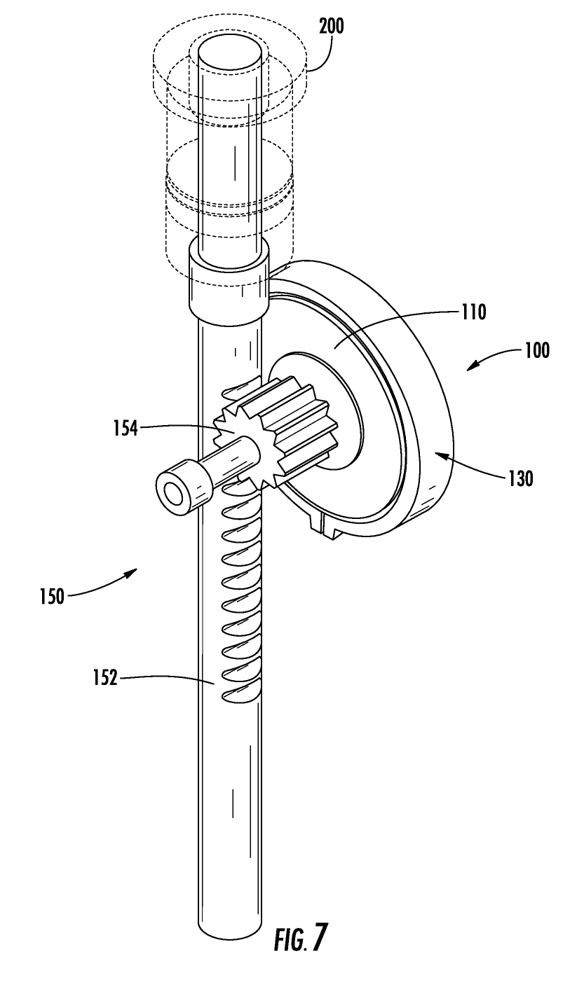

Referring now to FIGS. 5-9, an exemplary embodiment of brake assembly 100 is provided illustrating the connection between external motive input 200 and rotary output device 300. As discussed above, coupling element 150 couples external motive input 200 to rotor 120. In the particular configuration shown in FIGS. 5-9, for example, coupling element 150 comprises a rack-and-pinion system in which a rack 152 is coupled to external motive input 200, and a pinion 154 is coupled to rotor 120 (not shown in FIGS. 6 and 7 to illustrate the relative positions of underlying elements) for rotation together with rotor 120 about a common central axis. Rack 152 includes a plurality of rack teeth 153, and pinion 154 includes a plurality of pinion teeth 155 circumferentially positioned about an outer edge and configured to mesh with rack teeth 153. In this way, movement of rack 152 caused by operation of external motive input 200 (e.g., substantially linear oscillation) causes pinion 154 to rotate, which thereby rotates rotor 120.

Pinion 154 and/or rotor 120 are then further connected to an output shaft 310 configured for connection to rotary output device 300. Accordingly, brake assembly 100 is provided in the coupling connection between external motive input 200 and rotary output device 300 such that actuation of brake assembly 100 (e.g., by energizing coil 112 of brake core 110) resists the actuation force of external motive input 200 to hold output shaft 310 in place to keep rotary output device 300 in a desired operating position. For example, where rotary output device is a butterfly valve, brake assembly 100 can be selectively actuated to hold the valve in an intermediate position between first and second angular positions that correspond to the fully “open” or “closed” positions of the valve.

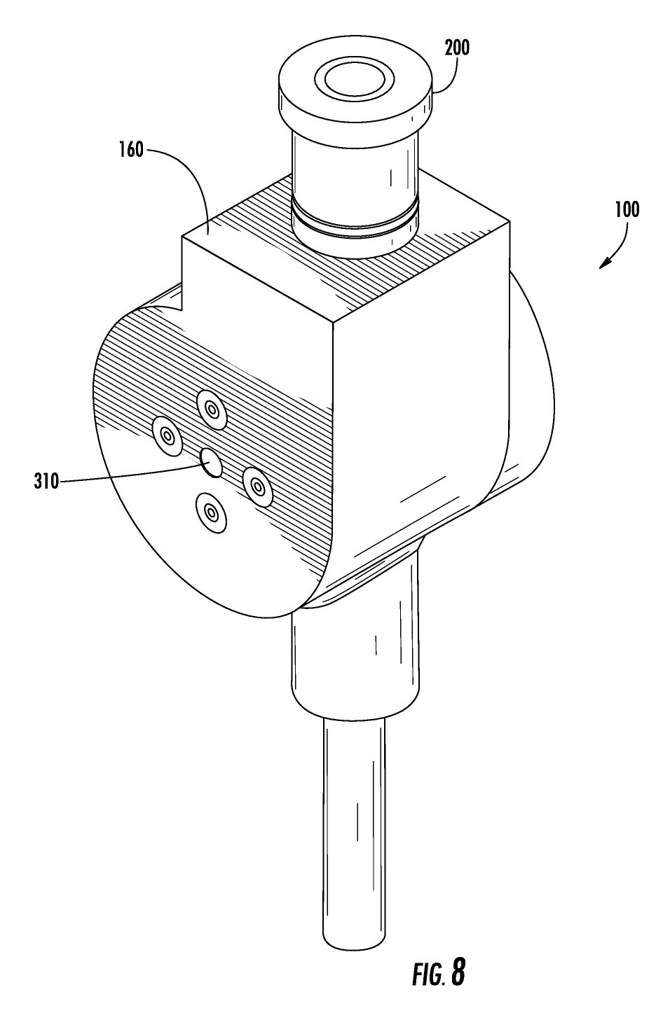

Furthermore, as shown in FIG. 8, in some embodiments, the motion control device comprises a housing 160 that surrounds rotor 120, brake core 110, and brake band 130 and protects many of the elements of brake assembly 100. In this configuration, brake core 110 is fixedly connected to housing 160 such that engagement of brake band 130 with brake core 110 causes brake band 130 to be held in a substantially fixed position, thereby stopping any rotation of rotor 120.

In an alternative configuration shown in FIGS. 10 and 11, coupling element 150 comprises a crank-style assembly rather than a rack-and-pinion system. In this configuration, rotor 120 is coupled to a crank arm 157 for rotation together, and crank arm 157 is coupled to external motive input 200 by a connecting rod 156. For example, crank arm 157 may be coupled to an end of connecting rod 156 using any of a variety of known bearing elements that allow for relative rotation of the ends of crank arm 157 and connecting rod 156 while still converting the translation of connecting rod 156 caused by external motive input 200 into a rotation of crank arm 157, which correspondingly results in the rotation of rotor 120. For example, crank arm 157 may be coupled to an end of connecting rod 156 using any of a ball joint, a pin, a yoke, a rod, a hook, or any other type of fastener or connector. Again, as with the previous configuration discussed above, in this configuration, rotor 120 is connected to an output shaft 310 to cause a rotation in rotary output device 300. In the particular configuration shown in FIGS. 10 and 11, output shaft 310 extends through brake core 110 for connection to rotor 120. In contrast to the rack-and-pinion-style configuration, however, this embodiment of brake assembly 100 requires no gearing, which can improve the manufacturability of the device.

In this way, actuation of external motive input 200 that causes a movement of connecting rod 156 is translated into a rotation of rotor 120 by crank arm 157. In contrast, brake core 110 is held in a substantially fixed position, such as by connection to a bracket element 162 or other surrounding support structure. Accordingly, upon energizing coil 112 of brake core 110, brake band 130 engages brake core 110 as discussed above, which couples rotor 120 to brake core 110. Since brake core 110 is held in a substantially fixed position, rotation of rotor 120 is resisted, thereby holding output shaft 310 in a desired angular position.

In another alternative configuration shown in FIG. 12, the connection of rotor 120 and external motive input 200 includes a yoke-type of connector comprising a slot 158 integral with or otherwise attached to connecting rod 156, whereby slot 158 interfaces with a pin 159 which is integral with or otherwise attached to rotor 120 such that the orientation of connecting rod 156 to external motive input 200 is unchanged by angular rotation of rotor 120.

In any configuration, brake assembly 100 is selectively operable to either prevent or allow the translation of motion from external motive input 200 to rotary output device 300, and in some situations, brake assembly 100 is operable to hold rotary output device 300 at a desired position. In this regard, upon receipt of a first control input (e.g., from controller 400), an electric current is applied to coil 112, which causes brake band 130 to be magnetically coupled to brake core 110 to prevent relative movement between rotor 120 and brake core 110. In this way, the position of rotary output device 300 is effectively fixed at a desired state or position. Conversely, upon receipt of a second control input, the electric current is disconnected from coil 112, which causes brake band 130 to be decoupled from brake core 110 to allow free rotation thereof.

In addition to the embodiments discussed above, those having skill in the art will recognize that the principles discussed herein can be implemented using other electromagnetically-actuated configurations. For example, rather than using a brake band positioned between a rotor and a brake core as discussed above, rotor 120 is encapsulated within a housing that contains a field responsive material. For example, the principles disclosed at Column 6, lines 1-20, at Column 7, lines 54-61, and at Column 9, lines 53-57, of commonly owned and assigned U.S. Pat. No. 6,854,573, the entire disclosure of which is hereby incorporated herein by reference, can be applied to achieve a controllable brake in which a rotor is housed within a chamber containing a field controllable material. In this configuration, the field controllable material is selectively acted upon by a magnetic field generator to change the rheology of the material and thereby impede movement of the rotor. (See, also, corresponding disclosures found in commonly owned and assigned U.S. Pat. Nos. 7,198,140, and 8,397,883)

In some embodiments, devices, systems, and methods provided herein are configured to be “fail-safe”, meaning that the locking device will automatically revert the position of the actuated device a default or “safe” position upon actuation failure and/or failure of any electrical and/or magnetic member or component associated with the devices and/or systems described herein. Such a default state can be achieved by including a biasing element (e.g., an unpowered spring) in one or more of brake assembly 100, external motive input 200, and/or rotary output device that urges the system towards the fail-safe position (e.g., a fully-open position) when no actuating forces are applied.

Electromagnetic locking devices and systems described herein may be devoid of multiple bearings and/or gears therein. The electromagnetic devices and systems provided herein may be sealed from the outside via a single bearing or seal, but may be devoid of additional bearings. The electromagnetic devices and systems provided herein may be operable between and including temperatures of at least about −40° C. to about 220° C., although those having ordinary skill in the art will recognize that the temperature range in which the present devices and systems are operable can be adjusted selectively through the use of coil wire insulation material or other known means for temperature control.

Other embodiments of the current subject matter will be apparent to those skilled in the art from a consideration of this specification or practice of the subject matter disclosed herein. Thus, the foregoing specification is considered merely exemplary of the current subject matter with the true scope thereof being defined by the following claims.

What is claimed is:

1. A motion control device for a rotary actuator system, the motion control device comprising:
a brake core includes a coil configured to generate an electromagnetic field when an electric current is applied;
a rotor positioned about and rotatable relative to the brake core;
a brake band positioned between the rotor and the brake core, the brake band being coupled to the rotor for rotation therewith and includes a magnetically responsive material;
an external motive input coupled to the rotor, the external motive input being movable to cause the rotor to rotate relative to the brake core;
a rotary output device coupled to the rotor and configured for angular movement upon rotation of the rotor relative to the brake core; and
an external control input configured to selectively provide the electric current to the coil;
wherein energizing the coil causes the brake band to be magnetically coupled with the brake core to prevent relative movement between the rotor and the brake core.

2. The motion control device of claim 1, wherein the brake core comprises a material selected from the group consisting of iron, nickel, cobalt, a ferromagnetic material, and steel.

3. The motion control device of claim 1, wherein the brake band is coupled with the rotor by a cup that is positioned between the rotor and the brake band, the cup being coupled to both the rotor and the brake band for rotation together.

4. The motion control device of claim 1, wherein the brake band is substantially ring-shaped with a gap in one portion of the ring, the brake band comprising one or more tabs that extend radially outward towards the rotor for coupling with the rotor.

5. The motion control device of claim 1, wherein the brake band is substantially ring-shaped and comprises:
a tab that interfaces with a recess in the rotor; and
a gap in one portion of the brake band;
wherein first and second circumferential portions of the brake band, one on each side of the tab, extend around and in a circumferential direction of the brake core, each of the first and second circumferential portions having a proximal end coupled to the tab, and a distal end of the first circumferential portion being separated from a distal end of the second circumferential portion by the gap.

6. The motion control device of claim 5, wherein the gap is formed at a position substantially diametrically opposite of the tab, whereby the brake band is configured to apply a substantially uniform holding force to the rotor regardless of which direction the rotor turns.

7. The motion control device of claim 5, wherein the gap is formed at a position in the brake band so that the first circumferential portion is longer than the second circumferential portion, whereby the brake band is configured to apply different holding forces to the rotor depending on which direction the rotor turns.

8. The motion control device of claim 1, wherein the external motive input is coupled to the rotor by a coupling element selected from the group consisting of a rack and pinion arrangement, a crank arm and connecting rod arrangement, and a yoke and connecting rod arrangement.

9. The motion control device of claim 1, wherein the external motive input comprises an actuator selected from the group consisting of a human input, a vacuum source, an electromechanical actuator, a magnetic source, a hydraulic source, a servo motor, an electrical motor, and combinations thereof.

10. The motion control device of claim 9, further comprising a controller configured to selectively actuate the external motive input.

11. The motion control device of claim 1, further comprising a housing that surrounds the rotor, the brake core, and the brake band.

12. The motion control device of claim 1, comprising lubricant between at least the brake band and the brake core.

13. The motion control device of claim 1, wherein the device is operable between and including temperatures of at least about −40° C. to about 220° C.

14. A method for adjusting, changing, and/or locking a position of an actuated device to any of a range of desired positions between two extreme states, the method comprising:
providing a rotor about and rotatable relative to a brake core, the brake core including a coil configured to generate an electromagnetic field when an electric current is applied;
providing a brake band between the rotor and the brake core, the brake band being coupled with the rotor for rotation therewith, the brake band including a magnetically responsive material;
coupling an external motive input to the rotor, the external motive input being movable to cause the rotor to rotate relative to the brake core;
coupling a rotary output device to the rotor, the rotary output device being configured for angular movement upon rotation of the rotor relative to the brake core;
upon receipt of a first control input, controlling a position of the rotary output device by applying the electric current to the coil, wherein applying the electric current to the coil causes the brake band to be magnetically coupled to the brake core to prevent relative movement between the rotor and the brake core; and
upon receipt of a second control input, disconnecting the electric current from the coil, wherein disconnecting the electric current from the coil causes the brake band to be decoupled from the brake core to allow free rotation therebetween.

15. The method of claim 14, wherein the brake band being coupled with the rotor for rotation therewith comprises providing a cup that is positioned between the rotor and the brake band, the cup being coupled to both the rotor and the brake band for rotation together.

16. The method of claim 14, wherein the brake band is substantially ring-shaped with a gap in one portion of the ring, the brake band comprising one or more tabs that extend radially outward towards the rotor; and
wherein the brake band being coupled with the rotor for rotation therewith comprises receiving the one or more tabs in a recess formed in the rotor.

17. The method of claim 14, wherein the brake band is substantially ring-shaped and comprises:
a tab that interfaces with a recess in the rotor; and
a gap in one portion of the brake band;
wherein first and second circumferential portions of the brake band, one on each side of the tab, extend around and in a circumferential direction of the brake core, each of the first and second circumferential portions having a proximal end coupled to the tab and a distal end of the first circumferential portion being separated from a distal end of the second circumferential portion by the gap.

18. The method of claim 17, wherein the gap is formed at a position in the brake band so that a first circumferential portion is longer than a second circumferential portion, whereby the brake band is configured to apply different holding forces to the rotor depending on which direction the rotor is driven by an actuating force.

19. The method of claim 14, wherein the external motive input is coupled to the rotor by a coupling element selected from the group consisting of a rack and pinion arrangement, a crank arm and connecting rod arrangement, and a yoke and connecting rod arrangement.

20. The method of claim 14, wherein controlling the position of the rotary output device comprises selectively operating a current source connected to the coil.

21. The method of claim 14, further comprising lubricating at least a space between the rotor and the brake core.
